(19) United States
(12) Patent Application Publication
(10) Pub. No.: US 2006/0130593 A1
(43) Pub. Date: Jun. 22, 2006

(54) Sensors

(75) Inventors: Les H. Richards, Round Rock, TX (US); Duke A. Ngo, Austin, TX (US); David A. Lang, San Diego, CA (US)

Correspondence Address: FULBRIGHT & JAWORSKI L.L.P., 600 CONGRESS AVE., SUITE 2400, AUSTIN, TX, 78701, US

(73) Assignee: BAE SYSTEMS Integrated Defense Solutions Inc.

(21) Appl. No.: 11/022,336

(22) Filed: Dec. 22, 2004

(51) Int. Cl. G01N 3/02

(52) U.S. Cl. 73/856

(57) ABSTRACT

Embodiments of a sensor that can be folded and stowed inside a compartment and then unfolded and deployed from the compartment for use in detecting objects laid on the ground or buried in the ground. Methods of manipulating such sensors.

### BACKGROUND

1. Field

The present invention relates to sensors that can be folded and stowed inside a compartment when the sensor is not deployed for use in scanning operations, and methods for manipulating sensors.

2. Description of Related Art

A number of different systems are used to detect objects laid on the ground or buried in the ground. These systems are often used to detect explosive objects, such as unexploded mines, grenades, munitions, and bombs. Many systems incorporate metal detectors designed for hand-held operation by a person on foot, but such systems are generally ineffective for scanning a large amount of territory in a relatively short amount of time. Vehicle-mounted systems are more effective for wide-area scanning operations such as the scanning of a road.

One vehicle-mounted system in the art, described in U.S. Pat. No. 6,343,534, employs an infrared camera mounted on the vehicle and positioned to obtain thermal signatures on the ground surface where the output of a vertically-oriented antenna coupled to a high power microwave source is directed. Another system, described in U.S. Pat. No. 5,869,967, encompasses a mine-detecting apparatus which has a jib on the front side of a mobile device on whose free end a detection device is arranged. The jib is capable of swiveling around a vertical and/or horizontal axis such that during forward movement, the jib executes an oscillating swinging movement. Another system, described in U.S. Pat. No. 5,452,639, is composed of an unmanned, remote-controlled vehicle containing sensors which face the ground and a second, manned vehicle which includes the devices required to control the first vehicle and the devices required to evaluate and display the sensor signals. Still another system, described in U.S. Pat. No. 6,333,631, incorporates an articulated arm with one or more mine detectors mounted at the end of the arm, the arm operating autonomously to repetitively sweep the mine detector in ever forward advancing side-to-side arcs over the terrain.

### SUMMARY

Embodiments of the present invention include a sensor that can be folded and stowed inside a compartment and then unfolded and deployed from the compartment for use in detecting objects laid on the ground or buried in the ground.

In some embodiments, the invention includes a sensor comprising a central section; two side sections, each side section being connected to the central section such that each side section can rotate substantially 180 degrees about a side axis between a folded position and a flat position; and a section supporting structure to which the central and side sections are connected such that central and side sections can rotate about a rear axis oriented substantially perpendicularly to the side axes between an upwardly-angled position and a downwardly-angled position when the side sections are in the flat position.

In other embodiments, the invention includes a sensor comprising (a) a central section having a top surface and (b) two side sections, each side section having a top surface, and each side section being connected to the central section such that the side sections can rotate between a folded position in which the top surface of each side section faces the top surface of the central section and a flat position in which the top surfaces of the side sections are substantially coplanar with the top surface of the central section. In one embodiment, the sensor further comprises a mechanism configured to (a) extend the central section and the side sections from a stowed position inside a compartment to a deployed position outside the compartment, (b) rotate the side sections from the folded position to the flat position and from the flat position to the folded position, and (c) retract the central section and the side sections from the deployed position to the stowed position.

In other embodiments, the invention includes a method for manipulating a sensor comprising (a) opening a sensor stowage compartment; (b) extending a sensor from a stowed position inside the sensor stowage compartment to a deployed position outside the sensor stowage compartment, the sensor comprising a central section and two side sections connected to the central section, each side section having a top surface; and (c) unfolding the two side sections from a folded position in which the top surface of each side section faces the top surface of the central section to a flat position in which the top surface of each side section is substantially coplanar with the top surface of the central section.

Additional embodiments of the present invention, and details associated with those embodiments, are described below.

### BRIEF DESCRIPTION OF THE DRAWINGS

The following drawings illustrate by way of example and not limitation. Identical reference numerals do not necessarily indicate an identical structure. Rather, the same reference numeral may be used to indicate a similar feature or a feature with similar functionality. Every feature of each embodiment is not always labeled in every figure in which that embodiment appears, in order to keep the embodiments clear.

FIGS. 1A-1D are perspective, top, front, and side views, respectively, of a motorized vehicle incorporating one of the present sensors, showing a deployed sensor that has been rotated downwardly to a detecting position.

FIGS. 2A-2D are perspective, top, front, and side views, respectively, of a motorized vehicle incorporating one of the present sensors, showing a deployed sensor having sections that are partially unfolded.

FIGS. 3A-3D are perspective, top, front, and side views, respectively, of a motorized vehicle incorporating one of the present sensors, showing the sensor in a partially stowed/partially deployed position.

FIGS. 4A-4D are perspective, top, front, and side views, respectively, of a motorized vehicle incorporating one of the present sensors, showing the sensor in a stowed position.

FIG. 5A is a perspective view of one of the present sensors in a flat, level position.

FIG. 5B is a perspective view of the sensor in FIG. 5A in a folded position.

FIG. 5C is a perspective view of the sensor in FIG. 5A in a detecting position.

FIG. 5D is an enlarged detail view of a portion of the view shown in FIG. 5C.

FIG. 6 is a perspective, partially-exploded view showing one manner of connecting and disconnecting sections of one of the versions of the present sensors shown in FIGS. 5A-5D.

FIG. 7A is a perspective, partially-exploded view of another embodiment of the present sensors, showing another example of how the sensors can be composed of removable sections.

FIG. 7B is an enlarged detail of a portion of the view shown in FIG. 7A.

FIGS. 8A-8E are a series of perspective views of an embodiment of the present sensors and a portion of its enclosure, showing a deployment sequence, including a calibrating position and a detecting position.

FIG. 9 is a perspective view of an embodiment of the present sensors and a portion of its enclosure, showing exemplary dimensions for both.

FIGS. 10A-10C are top, side, and rear views, respectively, of an embodiment of the present sensors, showing exemplary dimensions for the sensor when it is in a stowed position.

FIG. 11 is a side view of an embodiment of the present sensors, showing exemplary dimensions for the sensor when it is in a deployed position.

FIG. 12 is a perspective view of an embodiment of the present sensors, showing features of its deployment mechanism.

### DESCRIPTION OF ILLUSTRATIVE EMBODIMENTS

The terms “comprise” (and any form of comprise, such as “comprises” and “comprising”), “have” (and any form of have, such as “has” and “having”), “contain” (and any form of contain, such as “contains” and “containing”), and “include” (and any form of include, such as “includes” and “including”) are open-ended linking verbs. As a result, a sensor or method that “comprises,” “has,” “contains,” or “includes” one or more elements possesses those one or more elements, but is not limited to possessing only those one or more elements or steps. Likewise, an element of a sensor or method that “comprises,” “has,” “contains,” or “includes” one or more features possesses those one or more features, but is not limited to possessing only those one or more features. Furthermore, a structure that is configured in a certain way must be configured in at least that way, but also may be configured in a way or ways that are not specified.

The terms “a” and “an” are defined as one or more than one unless this disclosure explicitly requires otherwise. The terms “substantially” and “about” are defined as at least close to (and includes) a given value or state (preferably within 10% of, more preferably within 1% of, and most preferably within 0.1% of).

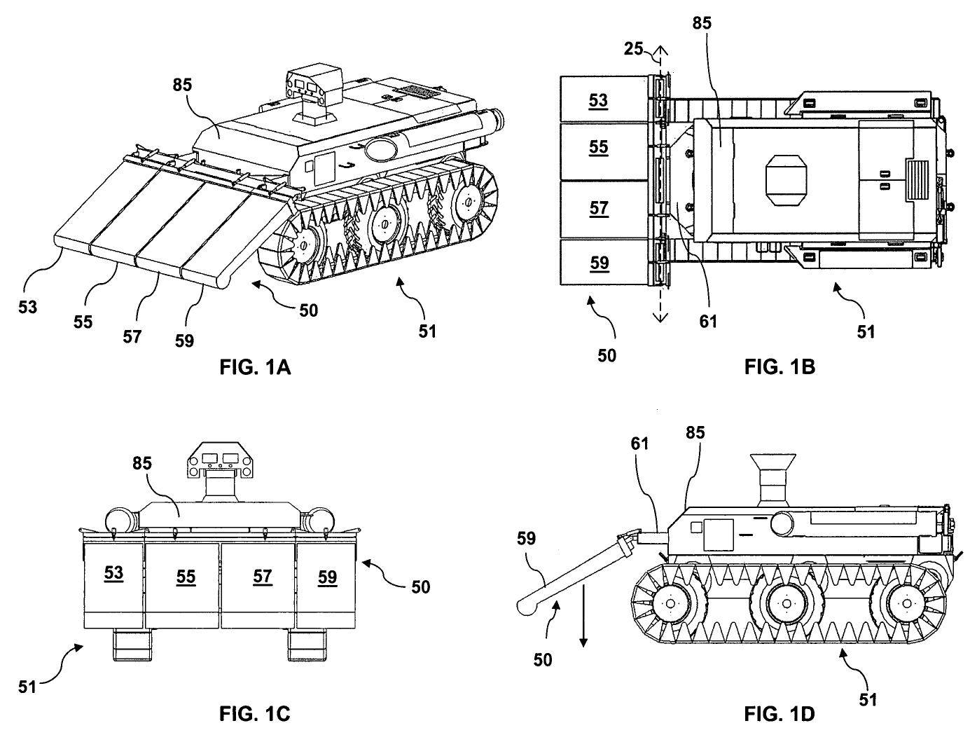

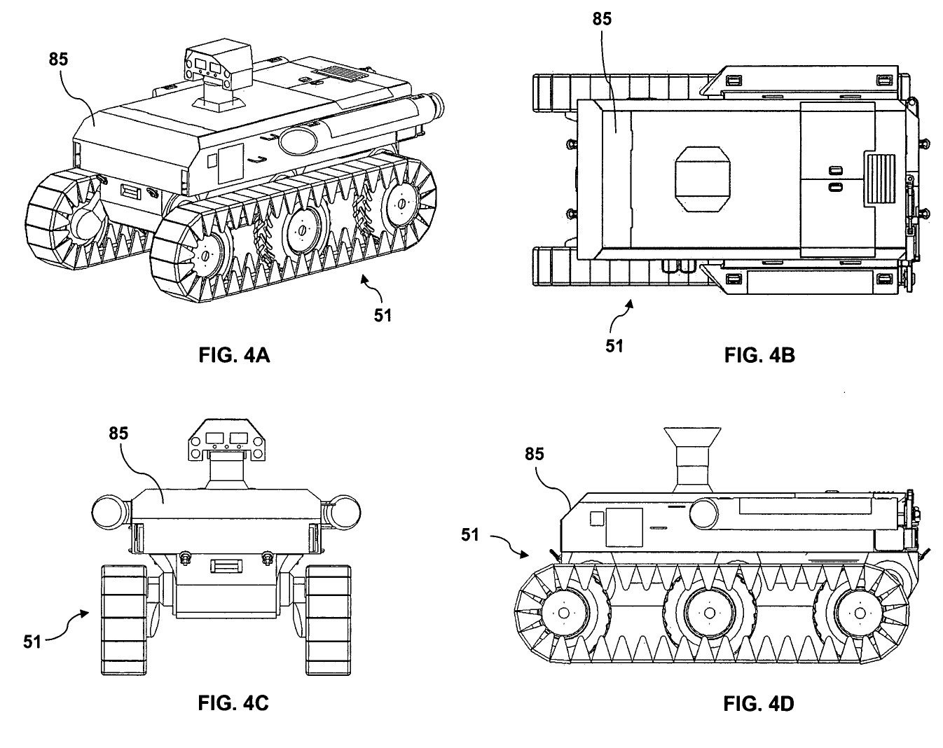

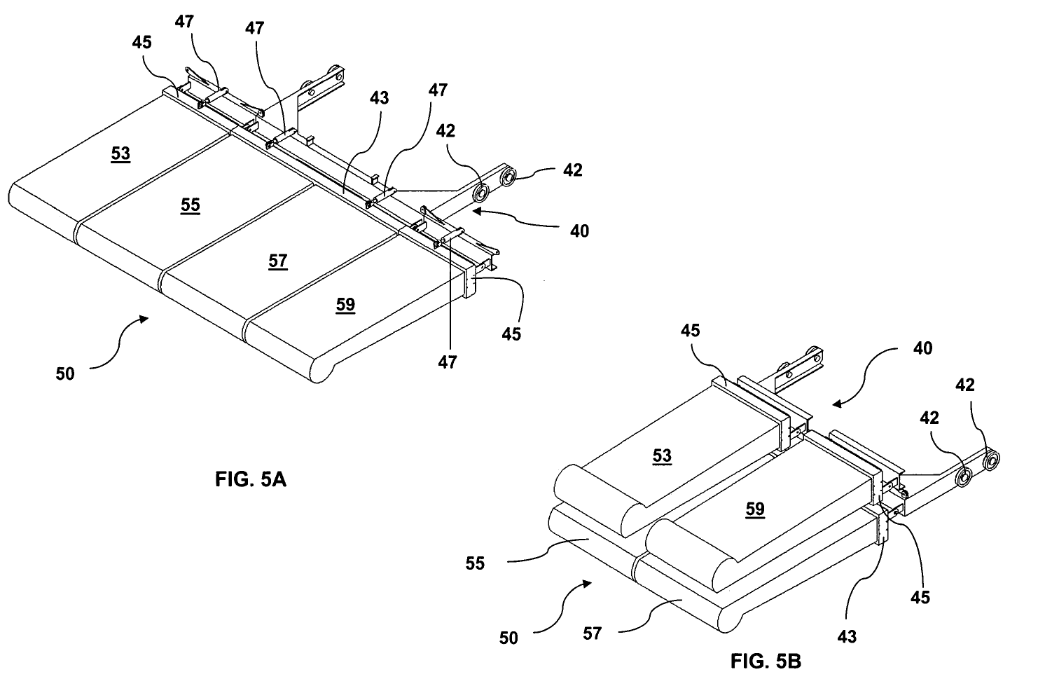

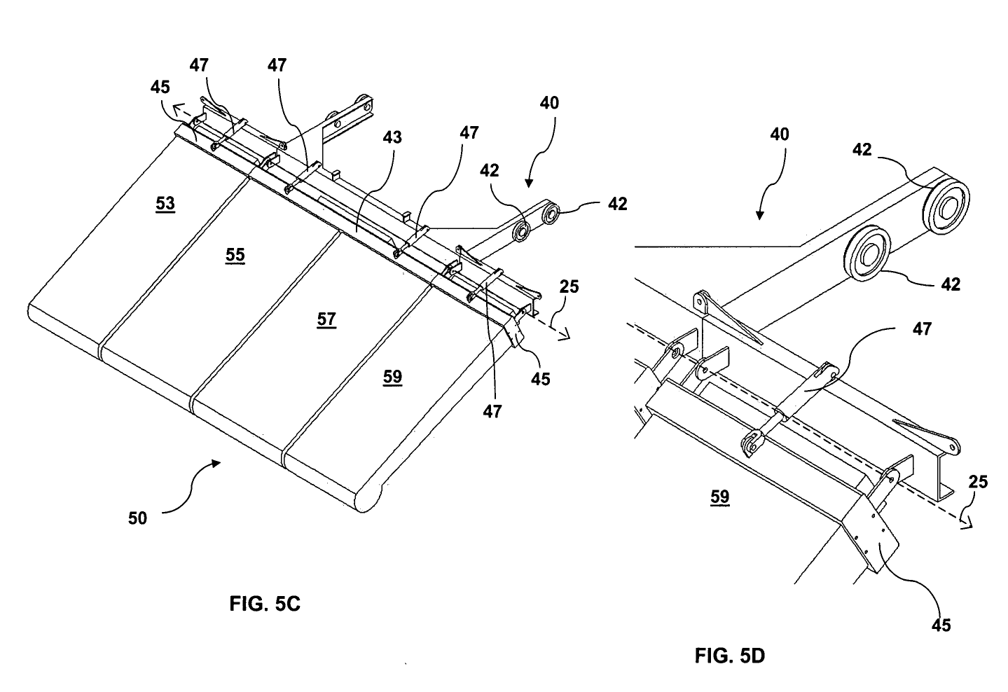

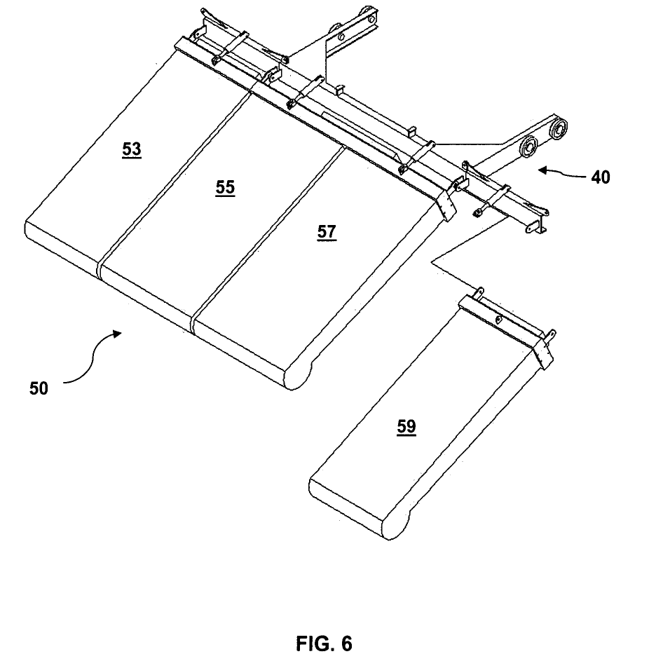

One embodiment of the present invention is the version of the present sensors shown in FIGS. 1A-1D, 2A-2D, 3A-3D, and 4A-4D as being connected to a motorized vehicle. These figures show an embodiment of the present sensors as it moves between its deployed and detecting position (FIGS. 1A-1D) and its stowed position (FIGS. 4A-4D). In FIGS. 1A-1D, motorized vehicle 51 includes sensor 50, which is composed of a central section that includes panels 55 and 57 (although a single panel could be used instead) and side sections that comprise panels 53 and 59. Sensor 50 is in its deployed and detecting position, as deployment mechanism 61 has fully extended sensor 50 from motorized vehicle 51. Side panels 53 and 59 are in a flat position because they are substantially coplanar with central section panels 55 and 57. When in that flat position, section panels 53, 55, 57, and 59 may be held rigid with respect to one another. Sensor 50 is in a detecting position because it has been rotated downwardly from a level position. The different sections of sensor 50 have rotated about axis 25 (see FIG. 1B), which may be characterized as a rear axis and which extends through the points at which the sections are hinged to a section supporting structure (discussed below in greater detail with respect to FIGS. 5A-5D). In this embodiment, axis 25 is substantially parallel with the ends of the sections that are capped (discussed in greater detail below). In this embodiment, axis 25 is also substantially perpendicular to the direction that sensor 50 travels when it is being deployed and retracted and, in this embodiment, to the ends and width of each section of sensor 50.

In the embodiments of the present sensors shown in the figures, the sections (and, thus, the panels that make up the sections) incorporate the Ground Penetrating Radar (GPR) sensor technology manufactured by Non-Intrusive Inspection Technology, Incorporated (NIITEK, Inc.; Sterling, Va.). Using the NIITEK GPR technology, the individual panels in some embodiments of the present sensors include individual antenna elements that are formed into an array of antenna elements (or an array of antennas) that is about 1.2 meters (or about 47.2 inches) wide by 0.15 meters (or about 6 inches) thick by 1.5 meters (or about 60 inches) long. In these embodiments, the individual antenna elements are constructed of rigid foam covered with a thin plastic laminate forming a relatively rigid structure, and multiple antenna elements are bonded together to form a single panel. The transmitter and receiver electronics are mounted directly to the panels and connect via transmission lines to the antennae. Processing and data acquisition components reside within the vehicle. In the embodiments of the present sensors shown in the figures, the signals sent from the different sections of the sensor can travel substantially in the direction shown by the unlabeled arrow in FIG. 1D. A suitable detecting position for the sensor when NIITEK's GPR technology is used is a forty-five degree angle (downwardly) from a position level with the ground.

Sensing technology other than NIITEK's GPR can be used in other embodiments of the present sensors. For example, metallic coils or infrared cameras could be used as part of the sensing technology.

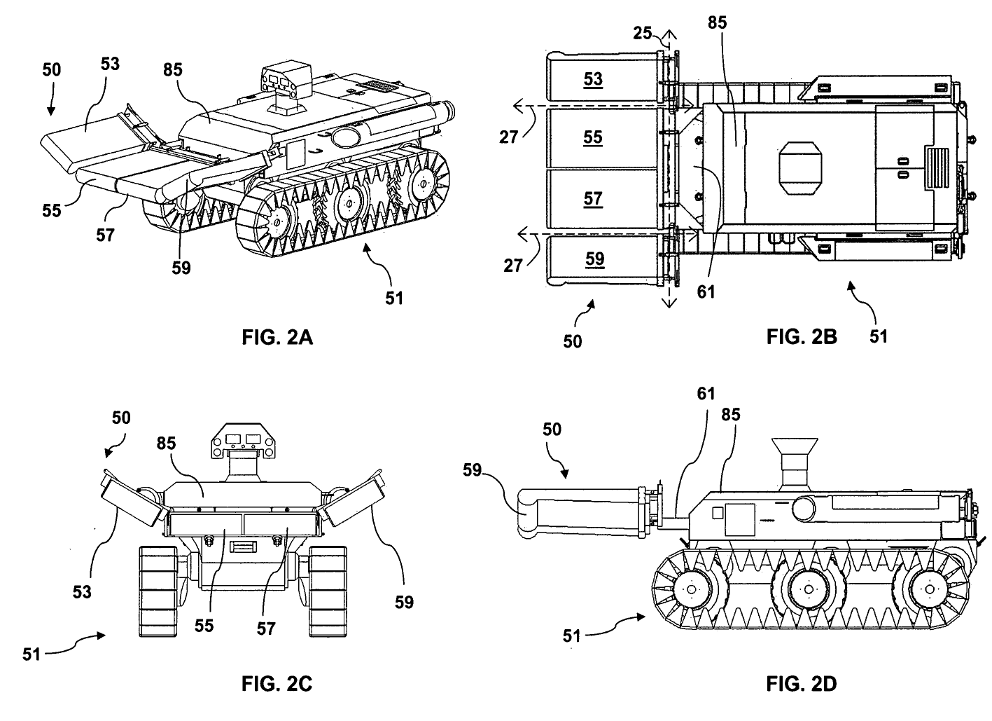

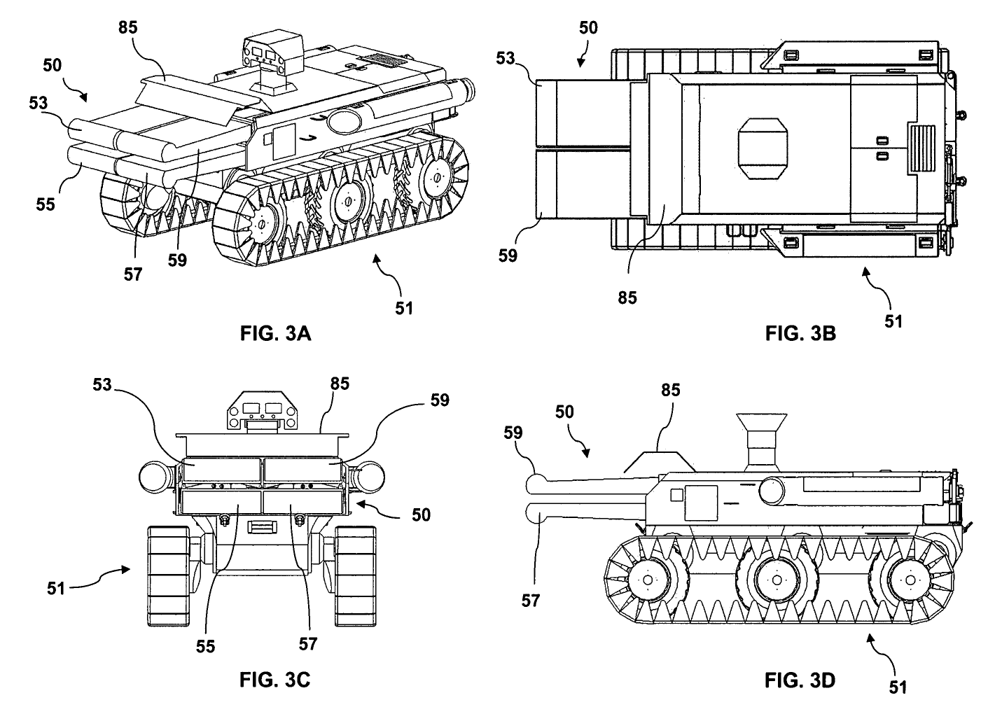

In FIGS. 2A-2D, sensor 50 of motorized vehicle 51 is shown in a partially deployed position. Side panels 53 and 59 are no longer in a flat position because they are no longer substantially coplanar with central section panels 55 and 57. Each side panel has been rotated about an axis 27 (also characterizable as a side axis) that is substantially perpendicular in this embodiment to axis 25. Each axis 27 is substantially parallel to the direction that sensor 50 travels when it is being deployed and retracted. Each axis 27 is also parallel, in this embodiment, with the sides and length of the sections of sensor 50. The side sections have been rotated less than 90 degrees in these figures, but they are capable (as demonstrated in FIGS. 3A-3D) of rotating from a level position up to substantially 180 degrees, and at any angle in between. In addition, the central section of sensor 50 is now in a level position in these figures, as deployment mechanism 61 has rotated the sensor upwardly about axis 25 from the detecting position shown in FIGS. 1A-1D such that sensor 50 is substantially parallel to the ground.

In FIGS. 3A-3D, sensor 50 of motorized vehicle 51 is shown in a partially stowed position. Side section panels 53 and 59 are in a folded position (e.g., have been rotated substantially 180 degrees about axes 27, not shown) because the top surface of each side section panel is facing one of the top surfaces of central section panels 55 and 57. In addition, sensor 50 is partially retracted into the sensor stowage compartment, which is not show in full, but which is covered at one end by sensor stowage compartment door 85, which is open.

In FIGS. 4A-4D, sensor 50 of motorized vehicle 51 is shown in its stowed position. The sensor is no longer visible outside motorized vehicle 51, as the sensor has been fully retracted inside the sensor stowage compartment, as evidenced by sensor stowage compartment door 85, which is closed.

FIGS. 5A-5D depict another embodiment of the present invention—sensor 50 without any driving mechanism. In this embodiment of the invention, the sections of sensor that are shown can move (e.g., are capable of moving) in any of the manners described above, when under appropriate force and control. Thus, side panels 53 and 59 of the embodiment of sensor 50 shown in FIGS. 5A and 5B are connected to the central section such that they can move to and from a flat position in which their top surfaces are substantially coplanar with the top surfaces of central section panels 55 and 57. Likewise, side panels 53 and 59 of the embodiment of sensor 50 shown in FIGS. 5A and 5B are connected to the central section such that they can move to and from a folded position in which their top surfaces are facing the top surface of the central section (e.g., the top surfaces of central section panels 55 and 57).

One end of each side section (e.g., side panel in this case) of sensor 50 is connected to a cap 45 that is connected (e.g., hinged, as shown in this embodiment) to panel supporting structure 40 (which also may be characterized as a section supporting structure), which comprises a brace to which multiple rollers 42 have been attached. The central section of sensor 50, which in this embodiment comprises two panels 55 and 57, is connected to one cap 43. Panel supporting structure 40 may be slidably coupled to an enclosure fitted with tracks in which the rollers 42 can slide. One actuator 47 is coupled to each cap 45, and two actuators 47 are coupled to cap 43. These actuators can be any suitable actuator known in the art capable of rotating the panels shown from a detecting position to a calibrating position.

In FIG. 5A, sensor 50 appears in a flat position. The panels can remain in this position (keeping them rigid) when the sensor is rotated, or articulated, between a calibrating position and a detecting position. FIG. 5B shows sensor 50 in a folded position because the top surface of each side section panel is facing one of the top surfaces of central section panels 55 and 57. FIG. 5B also shows that the outermost portions of panel supporting structure 40 may be hinged to the central portion of that structure. FIG. 5C shows sensor 50 in a detecting position, similar to the one shown in FIG. 1A. FIG. 5D is an enlarged detail of a portion of sensor 50 taken in the position shown in FIG. 5C. Thus, side section panels 53 and 59 and central section panels 55 and 57 are connected to a section supporting structure such that central and side sections can rotate between an upwardly-angled position and a downwardly-angled position when the side sections are in the flat position.

FIG. 6A shows how side panel 59 of the depicted embodiment of sensor 50, and generally how each of the sections of sensor 50 in this embodiment, may be removed from panel supporting structure 40.

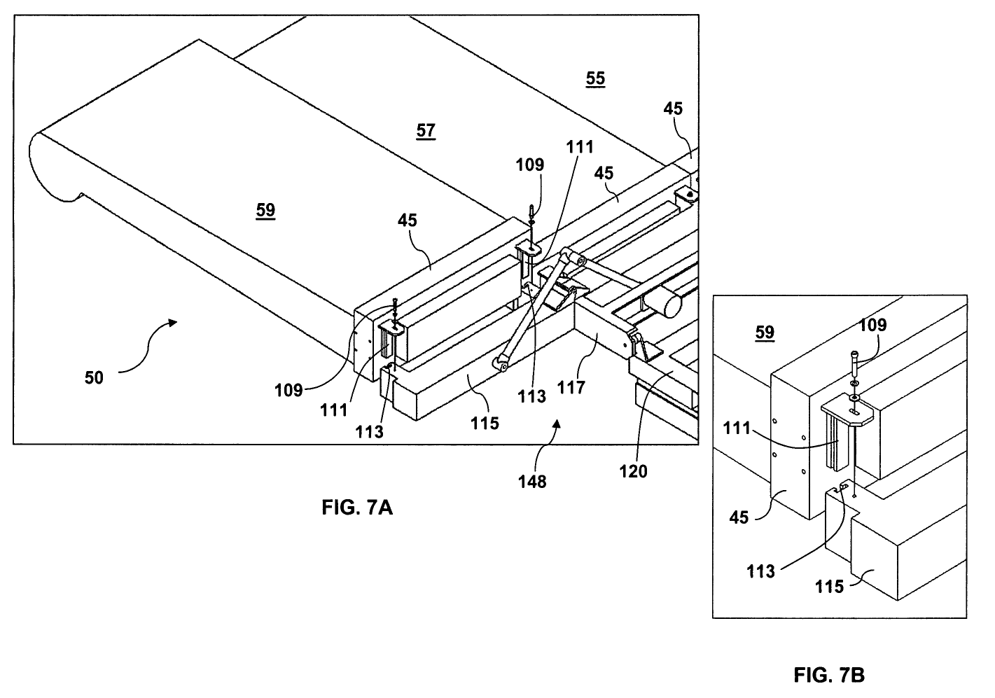

FIG. 7A shows another embodiment of sensor 50. This embodiment includes a cap 45 that is connected to an end of each of the panels 53 (not shown) through 59. One or more male connectors 111 are attached to the back of each cap 45. These male connectors 111 have a vertically-oriented flange that fits into a correspondingly-shaped female groove 113 of a portion of deployment mechanism 148 (only a portion of which is visible in this figure). Specifically, two such grooves are positioned in each of two side arms 115 of deployment mechanism 148. Male connectors 111 also have a top flange oriented substantially perpendicularly to the vertically-oriented flange. The top flanges each have a hole in them through which a screw, bolt or other suitable fastener 109 may be placed and used to secure the side sections to side arms 115. The central front frame section 117 is hinged to side arms 115, and includes similar features that allow for the similar attachment of the panels that form the central section of this embodiment of sensor 50. Together, side arms 115 and central front frame section 117 form another version of the present section supporting structures (also characterizable as panel supporting structures). FIG. 7B shows an enlarged detail view of the connection between panel 59 and deployment mechanism 148. While the central section of any of the present sensors can be composed of one large panel or two or more smaller panels, using panels of identical size for both the side sections and the central section allows for ease of logistics and battle damage repair.

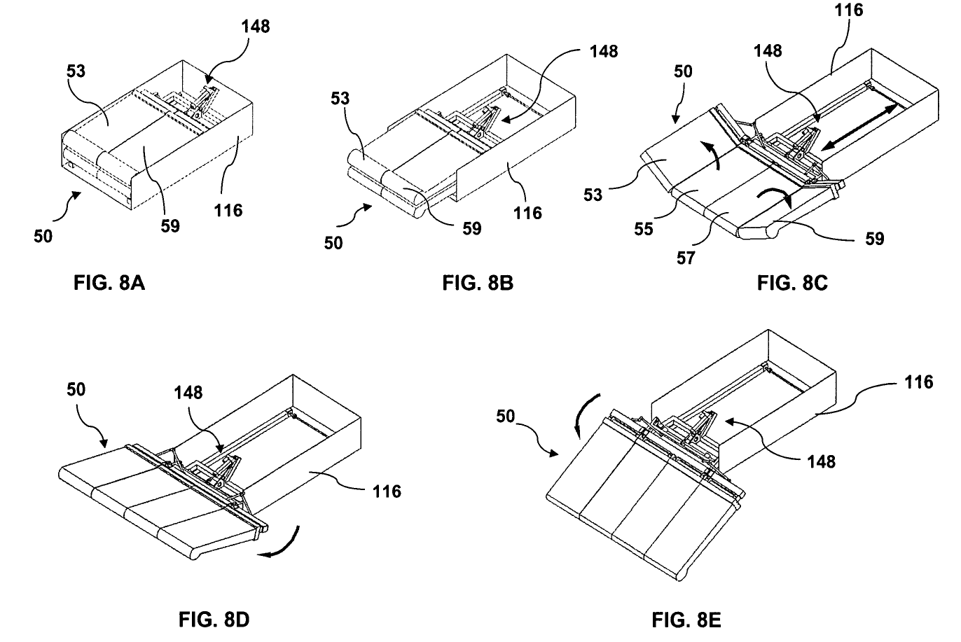

FIGS. 8A-8E depict the embodiment of sensor 50 shown in FIGS. 7A and 7B in a portion of its enclosure 116 as the sensor moves from its stowed position to its deployed position, from a folded position to an unfolded position, from a level position to a calibrating position, and from a level position to a detecting position. In FIG. 8A, sensor 50 is fully stowed within the portion of its enclosure 116 that is shown. Side panels 53 and 59 are in a folded position. In FIG. 8B, deployment mechanism 148 has partially deployed sensor 50 from its enclosure 116. In FIG. 8C, deployment mechanism 148 has fully deployed sensor 50 from its enclosure and has begun the process of rotating side section panels 53 and 59 into a flat position. In FIG. 8D, side section panels 53 and 59 have reached a flat position and sensor 50 has been rotated (upwardly) from a level position to a calibrating position. The purpose of calibrating the sections of a sensor that incorporates a sensing technology such as NIITEK's GPR technology is to allow the sections (e.g., the panels containing antennae) to send signals a sufficient distance without ground interference. In embodiments of the invention that utilize NIITEK's GPR technology, one suitable calibrating position is approximately forty-five degrees above the level position. In such a calibrating position, some of the signals sent from one or more of the different sections of the sensor may travel in a direction that is substantially parallel to the ground. Other calibrating positions may be possible. In FIG. 8E, sensor 50 has been rotated from a level position to a detecting position. In some embodiments of the invention, the rotation to reach the detecting position from the level position is approximately forty-five degrees below (e.g., downwardly from) the level position. The total time elapsed for the version of the deployment sequence depicted by FIGS. 8A-8E is approximately 20-30 seconds.

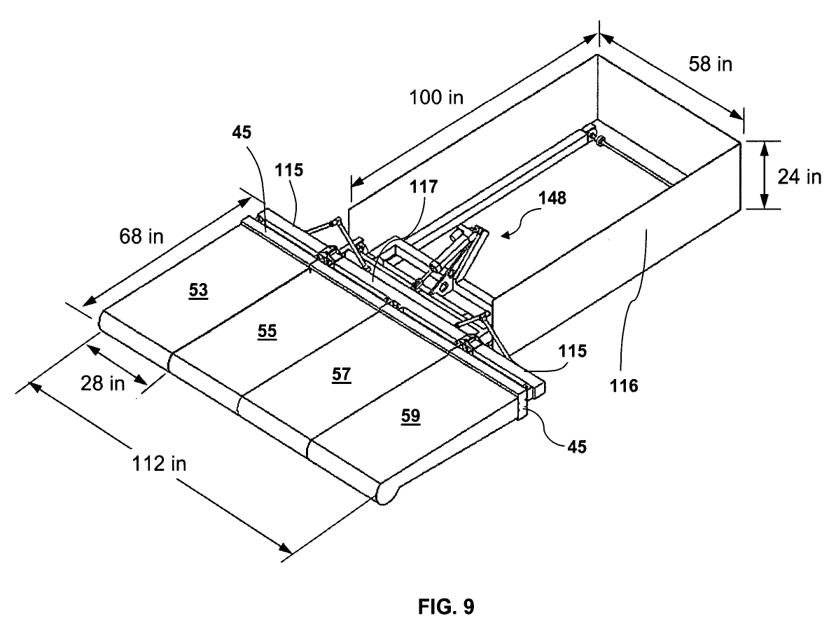

FIG. 9 depicts in greater detail the embodiment of the present sensors depicted in FIGS. 7A-8E with the sensor in its deployed position and side section panels 53 and 59 in a flat position. In this embodiment, the portion of enclosure 116 that is shown is about 2.5 meters (or about 100 inches) long, 1.47 meters (or about 58 inches) wide, and 0.6 meters (or about 24 inches) tall. Side section panels 53 and 59 and central section panels 55 and 57 are each about 0.7 meters (or about 28 inches) wide and 1.7 meters (or about 68 inches) long, including the caps and depth of side arms 115 and central front frame section 117. In this embodiment, the panels each weigh approximately 41 pounds and are approximately 0.15 meters (or about 6 inches) thick.

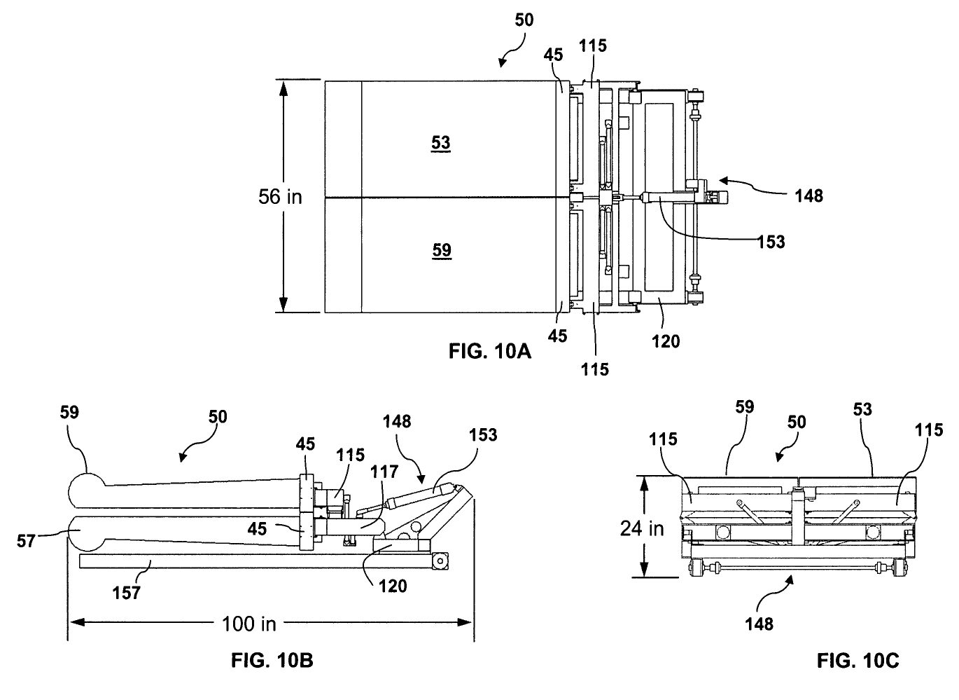

FIGS. 10A-10C depict the profile of the embodiment of sensor 50 shown in FIGS. 7A-9 with the sensor in its stowed position. These figures also depict deployment mechanism 148 of this embodiment of sensor 50 in additional detail from previous figures. FIG. 10B, which shows a side view of the sensor, shows that central front frame section 117 can be hinged to main frame 120. Electric cylinder 153 is connected to main frame 120. Electric cylinder 153 is also hinged to central front frame section 117 such that when the cylinder extends out of its casing, the panels tilt downwardly; and, when the cylinder retracts into its casing, the panels tilt upwardly. Main frame 120 is connected to the moving element of linear actuators 157. As the moving element slides down and back inside the box tube that houses the actuator, main frame 120 and, thus, the remainder of sensor 150 slide along from a deployed to a stowed position.

FIG. 10A shows that the width of sensor 50 in that folded position is about 1.4 meters (or about 56 inches). FIG. 10B shows that the length of this embodiment of the sensor and its deployment mechanism 148 when the sensor is in its stowed position is approximately 2.5 meters (or about 100 inches). FIG. 10C shows that the height of this embodiment of the sensor and its deployment mechanism 148 when the sensor is in a folded position is approximately 0.6 meters (or about 24 inches). In this embodiment, the total weight of sensor 50 and its deployment mechanism 148 is approximately 400 pounds (excluding the enclosure).

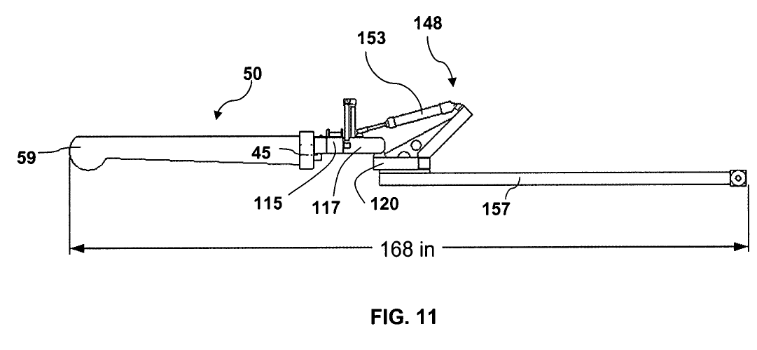

FIG. 11 depicts the profile of the embodiment of sensor 50 shown in FIGS. 7A-9 with the sensor in its deployed position. FIG. 11 shows that the length of this embodiment of the sensor and its deployment mechanism 148 when the sensor is in its deployed position is approximately 4.2 meters (or about 168 inches).

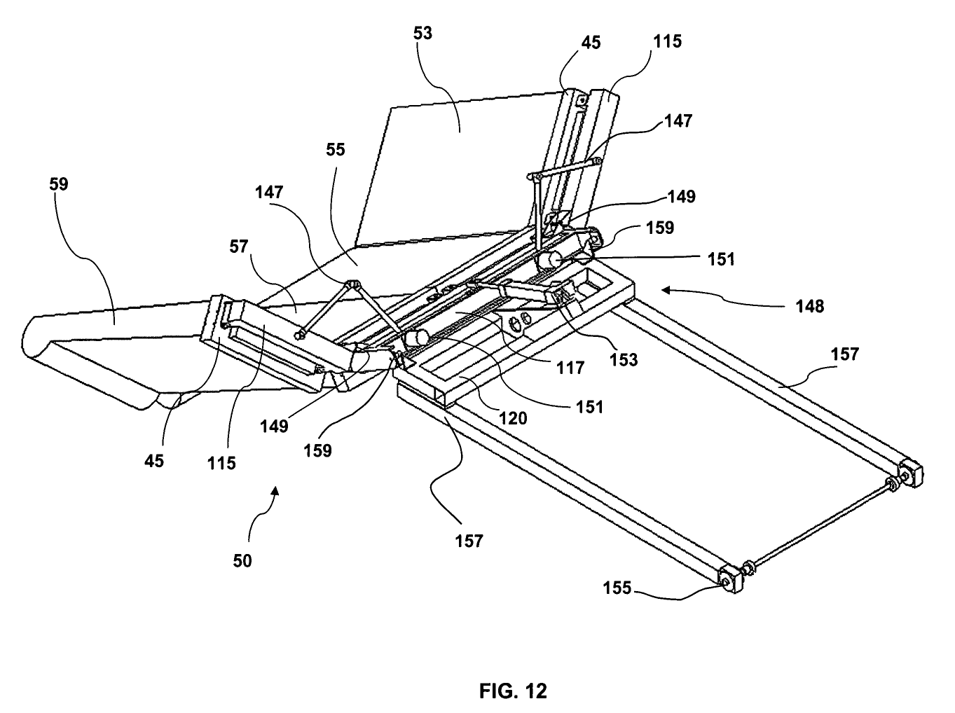

FIG. 12 depicts a rear perspective view of the embodiment of sensor 50 shown in FIGS. 7A-11, where the panels of sensor 50 are in a deployed position, and the side panels are in a partially folded position. Folding linkages 147 assist in rotating side section panels 53 and 59 from a folded position to a flat position and from a flat position to a folded position, and are driven by elements 151, which can be folding servo motors with inline gear heads. Hinges 149, which connect side arms 115 to central front frame section 117, allow side section panels 53 and 59 to rotate from a folded position to a flat position and from a flat position to a folded position. Hinges 159, which connect central front frame section 117 to main frame 120, allow sensor 50 (and, more specifically, the panels of sensor 50) to rotate from a level position to a detecting position, from a detecting position to a level position, from a level position to a calibrating position, from a calibrating position to a level position, from a calibrating position to a detecting position, and from a detecting position to a calibrating position. That motion can be driven by electric cylinder 153. Linear actuators 157 and motor gear drive 155 are responsible for moving sensor 50 from its stowed position to its deployed position and from its deployed position to its stowed position. Those of ordinary skill in the art will understand that there are many suitable commercially-available versions of the components of mechanism 148 depicted in the figures.

It should be understood that the present apparatuses and methods are not intended to be limited to the particular forms disclosed. Rather, they are to cover all modifications, equivalents, and alternatives falling within the scope of the claims. For example, although the side and central sections of the sensors shown in the figures are connected to each other such that the side sections rotate upwardly around the side axes shown, in other embodiments the side and central sections could be connected to each other (e.g., hinged) such that the side sections rotate downwardly around side axes such that the bottom surfaces of the side sections face the bottom surface of the central section. The bottoms of the sides and central portion of the section supporting structure could be hinged together (rather than the tops, as shown, for example, in FIGS. 5A-5D and FIG. 12) to achieve such a connection.

The claims are not to be interpreted as including means-plus- or step-plus-function limitations, unless such a limitation is explicitly recited in a given claim using the phrase(s) “means for” or “step for,” respectively.

We claim:

1. A sensor comprising:
a central section;
two side sections, each side section being connected to the central section such that each side section can rotate substantially 180 degrees about a side axis between a folded position and a flat position; and
a section supporting structure to which the central and side sections are connected such that central and side sections can rotate about a rear axis oriented substantially perpendicularly to the side axes between an upwardly-angled position and a downwardly-angled position when the side sections are in the flat position.

2. The sensor of claim 1, where each side section has a top surface and the central section has a top surface, the top surface of each side section faces the top surface of the central section in the folded position, and the top surfaces of the side and central sections are substantially coplanar in the flat position.

3. The sensor of claim 1, where the central section includes two panels, the side sections each include one panel, and each panel includes individual antenna elements bonded together to form an array of antenna elements.

4. The sensor of claim 3, where each panel is about 0.7 meters wide.

5. The sensor of claim 1, where each side section includes an outside edge, and the outside edges are about 2.8 meters apart when the side sections are in the flat position.

6. A sensor comprising:
a central section having a top surface;
two side sections, each side section having a top surface, each side section being connected to the central section such that the side sections can rotate between a folded position in which the top surface of each side section faces the top surface of the central section and a flat position in which the top surfaces of the side sections are substantially coplanar with the top surface of the central section; and
a mechanism configured to (a) extend the central section and the side sections from a stowed position inside a compartment to a deployed position outside the compartment, (b) rotate the side sections from the folded position to the flat position and from the flat position to the folded position, and (c) retract the central section and the side sections from the deployed position to the stowed position.

7. The sensor of claim 6, where the mechanism is further configured to rotate the central and side sections when the side sections are in the flat position from a level position in which the central and side sections are substantially parallel to the ground to a detecting position in which the central and side arrays have been rotated downwardly.

8. The sensor of claim 6, where the mechanism is further configured to rotate the central and side sections when the side sections are in the flat position from a level position in which the central and side sections are substantially parallel to the ground to a calibrating position in which the central and side sections have been rotated upwardly.

9. The sensor of claim 6, where the central section includes two panels, the side sections each include one panel, and each panel includes individual antenna elements bonded together to form an array of antenna elements.

10. The sensor of claim 9, where each panel is about 0.7 meters wide.

11. The sensor of claim 6, where each side section includes an outside edge, and the outside edges are about 2.8 meters apart when the side sections are in the flat position.

12. A method for manipulating a sensor comprising:
opening a sensor stowage compartment;
extending a sensor from a stowed position inside the sensor stowage compartment to a deployed position outside the sensor stowage compartment, the sensor comprising a central section and two side sections connected to the central section, each section having a top surface; and
unfolding the two side sections from a folded position in which the top surface of each side section faces the top surface of the central section to a flat position in which the top surface of each side section is substantially coplanar with the top surface of the central section.

13. The method of claim 12, further comprising rotating the central and side sections when the side sections are in the flat position from a level position where the central and side sections are substantially parallel to the ground to a detecting position where the central and side sections have been rotated downwardly.

14. The method of claim 12, further comprising rotating the central and side sections when the side sections are in the flat position from a level position where the central and side sections are substantially parallel to the ground to a calibrating position in which the central and side sections have been rotated upwardly.

15. The method of claim 13, further comprising rotating the central and side sections from the detecting position to the level position.

16. The method of claim 15, further comprising folding the two side sections into the folded position, retracting the sensor into the stowed position, and closing the sensor stowage compartment.

17. The method of claim 12, where the central section includes two panels, the side sections each include one panel, and each panel includes individual antenna elements bonded together to form an array of antenna elements.
